(19) United States
(12) Patent Application Publication
(10) Pub. No.: US 2009/0231720 A1
(43) Pub. Date: Sep. 17, 2009

(54) Heads up display

(76) Inventor: Mahesh K. Chengalva, Kokomo, IN (US)

Correspondence Address: DELPHI TECHNOLOGIES, INC., M/C 480-410-202, PO BOX 5052, TROY, MI, 48007, US

(21) Appl. No.: 12/075,546

(22) Filed: Mar. 12, 2008

(51) Int. Cl. G02B 27/14

(52) U.S. Cl. 359/630

(57) ABSTRACT

A heads up display apparatus for a vehicle having a windshield includes an LED display having alphanumeric characters which are at least reflected off of the vehicle windshield toward the driver. The display has power controls and, optionally, a variable brightness control through a manually driver manipulatable control member or automatically through an ambient light sensor output coupled to the display. A vehicle operating parameter output is coupled to the display and converted by the display into illuminated alphanumeric characters. Each element of each LED character includes a reflected element image and at least a partially refracted and reflected ghost element image which have juxtaposed and overlapped element to form a combined single image to the viewer.

### BACKGROUND

The present invention relates, in general, to heads up displays (HUD) and, more particularly, to heads up displays for automotive applications.

Heads up displays or HUD are known and are currently used in many military and commercial aircraft. HUDs are also finding application in automobiles. In an automotive application, a HUD unit is mounted in the automobile dashboard to project an image in front of the driver.

A HUD typically includes a video processor, a display unit or image source, a mirror and a combiner or windshield. Data is received from one or more vehicle computers or directly from various sensors to enable one or more types of data pertaining to vehicle operating conditions to be displayed by the HUD. Such data can include the vehicle speed, tachometer reading, turn signal operation, low/high beam headlight operation, fuel level, etc. to name a few.

While HUDs significantly enhance vehicle safety by minimizing driver distraction caused by having to look down at the instrument panel to determine the engine speed, or other vehicle operating parameters, only a fraction of vehicles on the road today are equipped with HUD technology. One of the reasons for poor market penetration for such a useful technology is cost. Consumers may like the HUE technology, but are not willing to pay a perceived high price for a HUD system. If the cost of the HUD system could be considerably lower, there would be the potential for a very large market for HUD systems in automotive applications. Thus, it would be desirable to provide HUD system for automotive applications which has a low cost.

### SUMMARY

A heads up display apparatus for a vehicle having a windshield includes an LED display mounted in the vehicle to reflect an alphanumeric output of the display from a vehicle windshield toward the vehicle driver.

In one aspect, a vehicle operating parameter input is coupled to the display. The vehicle operating parameter input may be at least one of the vehicle speed, the vehicle tachometer output, fuel quantity and vehicle turn signal condition.

In another aspect, a variable brightness control input is coupled to the display for controlling the brightness level of the LED display. The variable brightness input may be a user manipulated control member and/or an ambient light signal coupled to the display.

In another aspect, a control member is connected between a power source and the display for turning the display on and off.

Each element of each LED character includes a reflected element image and an at least partially refracted and reflected ghost element image which have juxtaposed and overlapped elements to form a combined single image to the viewer.

The present HUD apparatus has a low cost since a simple LED display is used thereby eliminating the complex imaging, mirror and processing required by prior art HUD systems which project an image in front of the driver. The present HUD system utilizes the inherent partial reflective property of a vehicle windshield thereby eliminating the need for special reflective coatings required in prior art HUED systems.

In addition, the present HUD system may receive inputs from a variety of vehicle operating parameter sensors, such as tachometer reading, fuel quantity, turn signal or headlight operation as well as vehicle speed. The brightness of the display may be adjusted manually by the operator or automatically via an ambient light sensor to brighten.

### BRIEF DESCRIPTION OF THE DRAWING

The various features, advantages, and other uses of the disclosed HUD apparatus will become more apparent by referring to the following detailed description and drawing in which:

FIG. 1 is a side elevational view of a heads up display apparatus mounted in the vehicle;

FIG. 2 is a pictorial representation of the HUD with inputs;

FIG. 3 is a pictorial representation of the image of the HUD display reflected from a vehicle windshield;

FIG. 4 is a pictorial representation of one of the HUD display LED elements;

FIG. 5 is a pictorial representation of one HUD display LED element which has non-optimized dimensions producing spaced reflected and ghost images;

FIG. 6 is a pictorial representation of one HUD display LED element having optimized dimensions producing overlapped reflected and ghost image; and

FIG. 7 is an enlarged front pictorial view of the overlapped reflected and ghost images of one entire HUD display character.

### DETAILED DESCRIPTION

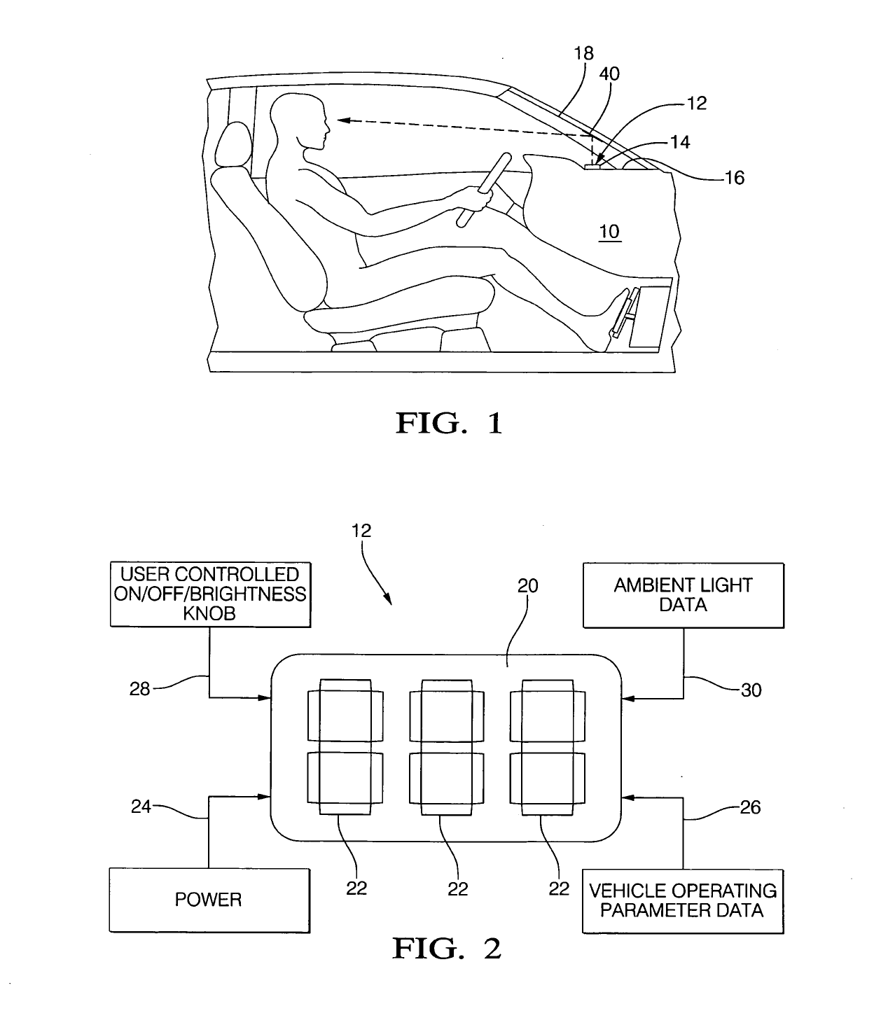

Referring now to FIG. 1, an automobile 10 is shown equipped with a heads up display apparatus (HUD) 12. The HUD 12 communicates information to the vehicle operator via an image reflected off of the inner surface of the vehicle windshield 18 within the driver's visual line of sight. The HUD 12 allows the driver to receive vehicle operating information without taking his eyes off of the road or from the forward direction of movement of the vehicle.

The HUD 12, as shown in FIG. 2, includes a luminous LED digital display 20 capable of forming one or more independent alphanumeric characters 22 in a housing 14 mounted on or in a vehicle dashboard 16. Three characters 22 are shown by way of example only. Seven elements 22A, 22B, 22C, 22D, 22E, 22F and 22G make up each LED character 22 to enable alphanumeric characters to be generated.

The seven LED elements 22A, 22B, 22C, 22D, 22E, 22F and 22G are arranged in a general figure eight pattern as shown in FIG. 4. Each LED element, 22A, 22B, 22C, 22D, 22E, 22F and 22G, is discrete and contacts other LED elements 22a-22G only at one edge, as also shown in the FIG. 4.

Each LED character 22 is symmetrical both in longitudinal and lateral directions. As the display 20 is mounted on a generally horizontally extending surface, such as the vehicle dashboard 16, the laterally extending LED elements, 22A, 22B, and 22C of each LED character 20 are horizontally oriented, from the reference point of the vehicle driver, and will be reflected and refracted, as described hereafter, from the vehicle windshield 18 to appear in a laterally or horizontally extending direction to the vehicle driver. However, the horizontal reflected and refracted LED elements 22A and 22C will be inverted from the same element in the display 20. Likewise, the longitudinally extending LED elements 22B, 22E, 22F and 22G, when viewed in a mounting orientation on the vehicle dashboard 16, are reflected and refracted from the vehicle windshield 82 to appear in a vertically extending orientation to the driver.

Electrical power 24, such as a 12-volt d.c. power, is input to the HUD 12 from the vehicle electrical system or vehicle battery.

A vehicle operating parameter input 26 is also input to the display 20. The display 20 includes circuitry for converting the input 26 to a single or multi-character alphanumeric display. For example, the input 26, i.e., numerals, letters, etc., can be the vehicle speed sensor data received directly from the vehicle speed sensor or from one of the vehicle computers which receives the vehicle speed sensor data directly from the speed sensor. The input 26 may also be other vehicle operating parameters, such as dynamic parameters, i.e., tachometer output, fuel level sensor output, engine fluid pressure levels, tire pressure, etc., as well as more static parameters, such as turn signal or headlight state, door lock or unlock state, etc.

A control member, such as an on/off switch 28, is also input to the display 20 for controlling the application of electric power through the power source input 24 to the display 20. The control member 28 may be a rotary knob having circumferentially spaced on and off positions.

The control member or rotary knob input 28 may also be connected to a voltage control circuit to vary the voltage applied to the display 20 from the power source 24 in order to control the brightness of the display characters 22 to accommodate ambient light conditions or according to the driver's preference.

The display 20 may also receive an input 30 which provides ambient data, such as the output of a photocell mounted on the vehicle dashboard 16 or at any of other suitable locations within the vehicle. The ambient light input 30 controls the voltage applied to the display characters 22 in the same manner as the brightness control member input 28 by varying the voltage applied to the display characters 22.

The display 20 is also adaptable to receiving multiple vehicle operating parameters similar to the input 26. Such parameters can be controlled by a selector switch, such as a slide switch or a rotary switch, to enable the vehicle driver to select between various vehicle parameters for display on the display characters 22. As mentioned previously, such other inputs can include the tachometer output, fuel level, turn signal or headlight operation, engine oil pressure, etc.

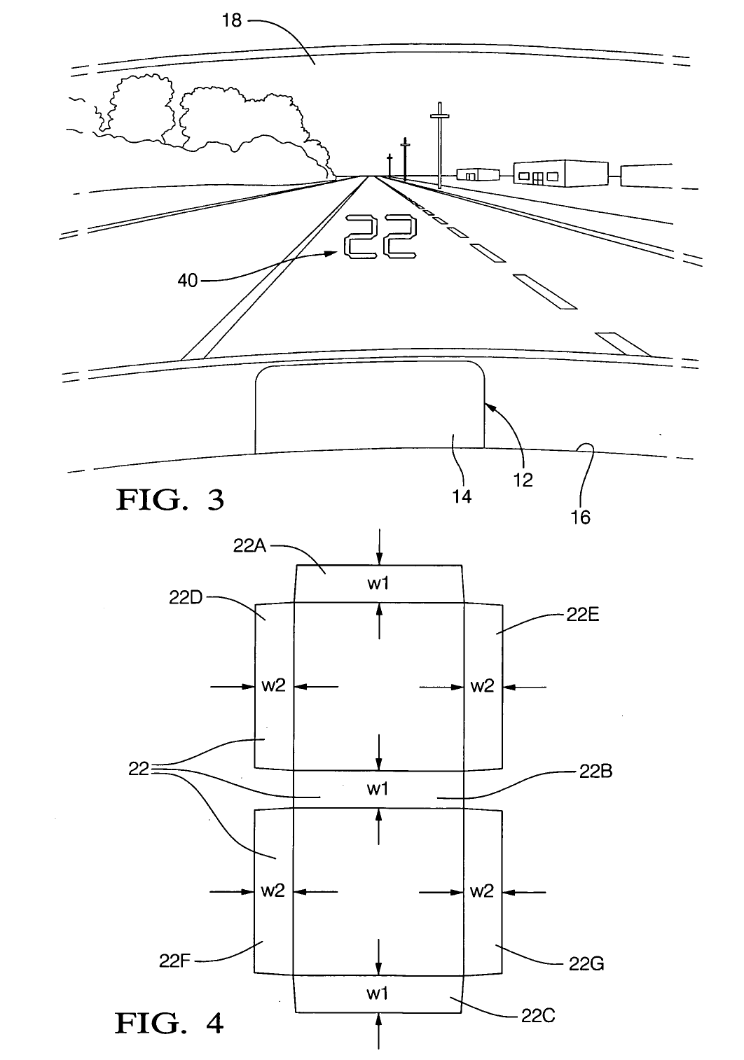

To generate a clear image 40 in the driver's field of view, as shown in FIG. 3, each LED element 24A, 24B, 24C, 24D, 24E, 24F and 24G of each LED character 22 have uniform illumination throughout the display surface of each element rather than being brighter toward the center region of each display surface. This could eliminate the need for a lens or a coating on the LED display 20 or a coating 18 on the vehicle windshield. It may also be possible to vary or increase the width of the vertical elements 22D, 22E, 22F, and 22G as compared to the width of the horizontally extending LED elements 22A, 22B, and 22C to produce an optimized, clear image. In the following example, for example only, the length of each element 22A, 22B, 22C, 22D, 22E, 22F, and 22G is held at a constant, identical dimension.

The following equations are employed to optimize the dimensions of each LED element 22A, 22B, 22C, 22D, 22E, 22F, and 22G of each LED character 20.

W1=t*tan(θ)/cos(α)

Where θ=sin⁻¹(sin(α)/μ)

W2=4*t*tan(θ)*sin(α)

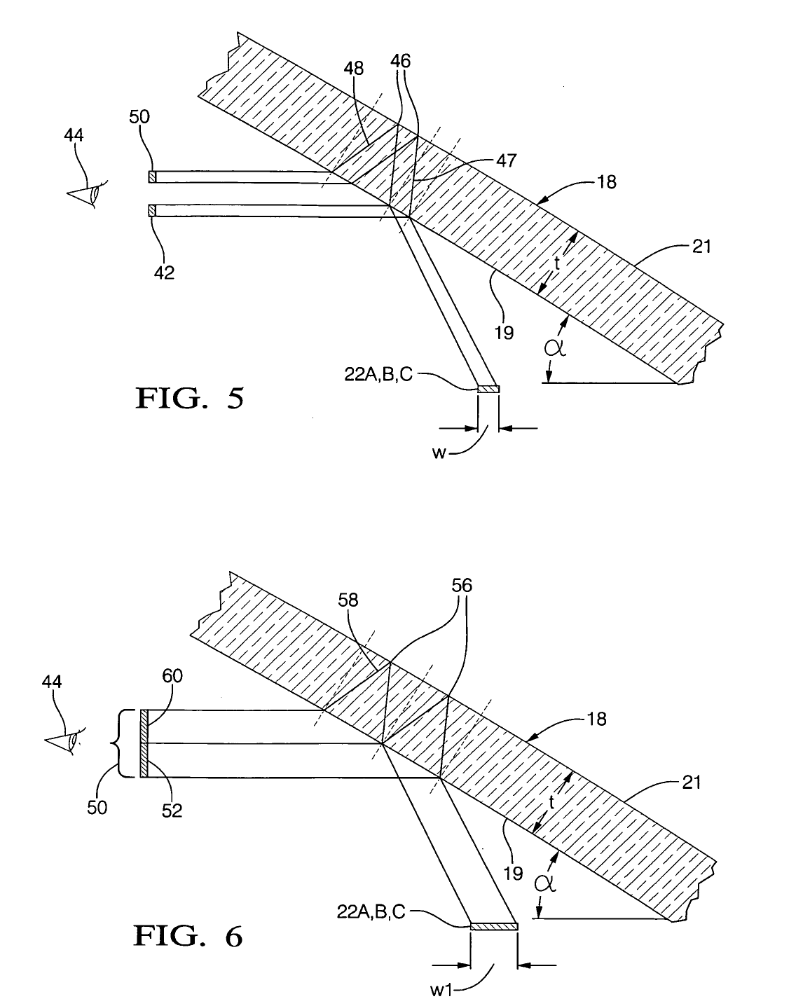

In the above formulas:
α is the windshield inclination angle shown in FIGS. 5 and 6
t is the windshield thickness
μ is the Refractive Index of the windshield 18 glass
w1 is the width of the horizontal LED elements 22A, 22B, 22C
w2 is the width of the vertical LED elements 22D, 22G, 22F, 22CA

### EXAMPLE

Consider the case where α is 30 degrees, μ is 1.5 (typical for glass windshields) and the thickness (t) of the windshield 18 is 8 mm

Computing θ=sin⁻¹(sin(30)/1.5),
this makes θ=19.47.

Inserting this into the equation for w1 yields:

w1=8*tan(19.47)/cos(30)
which makes w1==3.265 mm.

The optimal value of w2 is computed using

w2=4*8tan(19.47)*sin(30)
which makes w2=5.656 mm
   Therefore, for the given windshield 18 parameters, the optimal dimensions of the LED elements 22A-22G are w1=3.265 mm and w2=5.656 mm.

Referring briefly to FIG. 5, if LED elements 22A-22G of each LED character 22 have the same width dimensions as shown pictorially in FIG. 2, an image of the LED characters 22 will be reflected from the inner surface 19 of the windshield 18 as a reflected image 42 toward the driver's eyes 44. In addition, the LED characters 22 will be refracted as rays 47 by the inner surface 19 of the windshield 18 through the windshield 18 and reflected at points 46 by the outer surface 21 of the windshield 18 to form second reflected rays 48. The second reflected rays 48 will pass back through the thickness of the windshield 18 to the inner surface 19 of the windshield 18 where again they will be refracted by the inner surface 19 of the windshield 18 towards the driver's eye 44 as a ghost image 50 separate and spaced from the reflected image 42 at the driver's eyes 44. The reflected image 42 and the ghost image 50 are seen by the driver's eyes 44 as a composite image which, due to the spaced nature of the reflected image 42 and the ghost image 50, are seen by the driver's eyes 44 as a blurred or double image.

In FIG. 6, the optimized dimensions described above for the width of each LED element 22A-22G are employed. Each LED element 22A-22G is again reflected off of the inner surface 19 of the windshield 18 to form a reflected image 52 at the driver's eyes 44. The images of the LED element 22A-22G are also refracted by the inner surface 19 through the windshield 18 and are reflected at points 56 from the outer surface 21 of the windshield 18. The reflections form second reflected rays 58 which are again refracted by the inner surface 19 of the windshield 18 and directed toward the driver's eyes 44 as a ghost image 60.

The ghost image 60 will have less brightness or intensity than the reflected image 52. The amount of decrease in the brightness of the ghost image 60 relative to the reflected image 50 will depend on the type of glass used in the windshield 18 and the design of the windshield 18, such as the angle or inclination of the windshield 18 relative to the vehicle dashboard 16.

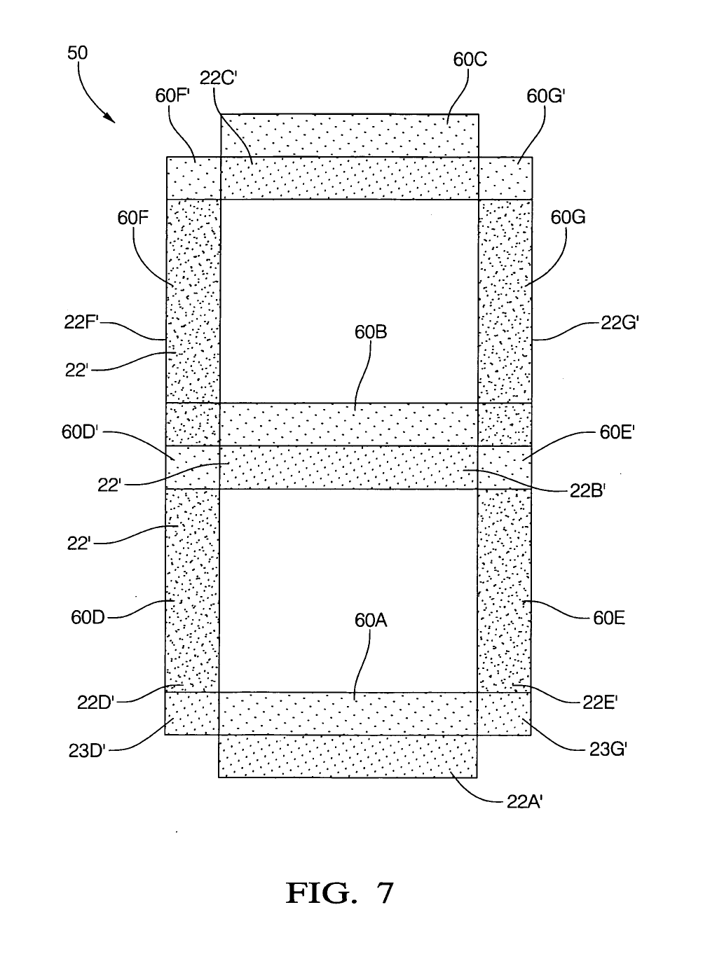

However, due to the optimized dimensions described above in which the vertically oriented LED elements 22D, 22E, 22F, and 22G have width larger that the width of the horizontally extending LED elements 22A, 22B, and 22C of each LED display character 22, the ghost image 60 is overlapped or juxtaposed horizontally and superimposed or overlaid vertically with the reflected image 52 at the driver's eyes 44, as pictorially shown in FIG. 7, to form a composite image 6. That is, the lower edge of the bottommost LED element 22C of the ghost image 60 is disposed immediately adjacent to or superimposed over the upper edge of the uppermost LED element 22C′ of the reflected image 52.

It should be noted that the arrangement of the LED elements 22A-22G shown in FIG. 4, which are as they appear when looking down at the upper surface of the display 12, are inverted by the windshield 18 to the arrangement shown in FIG. 7. The driver's eyes 44 combined the reflected image 52 and the ghost image 60 into a composite, single image 62 having clearly defined edges.

It should also be noted that the dimension w1 shown in FIG. 6 is the width w1 of one of the horizontally extending LED elements 22A, 22B, and 22C. For clarity in FIG. 7, these elements, which are inverted, as described above, by reflection and refraction by the windshield 18, are relabeled 22A′, 22B′, and 22C′. Likewise, the horizontally extending ghost image of each LED element 60A, 60B, and 60C is also inverted as shown in FIG. 7.

As clearly shown in FIG. 7, the ghost images of each LED element 60A, 60B, and 60C, which are of slightly less brightness or intensity than the corresponding horizontally extending elements 22A′, 22B′, and 22C′ of the reflected image 52, are juxtaposed or immediately adjacent to the horizontally elements 22A′, 22B′, and 22C′ of the reflected image 52 to form a combined horizontally extending element of the composite image 50.

Meanwhile, the vertically extending element of the reflected image 52, namely, LED elements 22B, 22E, 22F, and 22G, overlap corresponding vertically extending elements 60D, 60E, 60F and 60G of the ghost image 60. In the areas of overlap, denoted by combined element locations 22D′ and 60B, 22E′ and 60E, 22F′ and 60F, and 22G′ and 60G, the brightness or intensity of the corresponding reflected image elements and the ghost image elements combine and are additives to form bright elements in the composite image 62. Non-overlapped regions 23D′, 23E′, 60D′, 60E′, 60F′, and 60G′ which are formed by only a portion of one of the reflected image 52 or the ghost image 60 element, have a brightness or intensity substantially the same as the adjacent horizontally extending elements 22A′, 22B′, and 22C′ of the reflected image 52 or the adjacent portion of the ghost image 60 elements 60D, 60D, 60F and 60G.

While edge blurring of the LED elements forming the composite image 62 can occur, such as where a portion of a ghost image of the LED characters is juxtaposed or immediately adjacent to the reflected image 50, larger size LED's may be employed to minimize the effects of such edge blurring.

If low power LED's are employed in the display 14, increased the brightness of the composite image 62 may be attained by forming a translucent portion on the inner surface 19 of the windshield 18 which has increased reflectivity. This makes at least the reflected image 52 of the composite image 62 brighter.

It should be noted that the over all dimensions of the LED characters are not constrained by the above described optimization method. This permits greater flexible for designers because the overall dimension can be set to any desired size to match a given application configuration.

What is claimed is:

1. A heads up display apparatus for a vehicle having a windshield, the apparatus comprising:
an LED display having an alphanumeric LED character output mounted in the vehicle to at least reflect an image of the LED character output from a vehicle windshield toward a vehicle driver.

2. The apparatus of claim 1 further comprising:
a vehicle operating parameter input coupled to the display.

3. The apparatus of claim 2 wherein:
the vehicle operating parameter input is at least one of the vehicle speed, the vehicle engine rpm, the vehicle fuel quantity, the vehicle turn signal condition, and
the vehicle headlight condition.

4. The apparatus of claim 1 further comprising:
a brightness control input coupled to the display for controlling the brightness of the LED character output.

5. The apparatus of claim 4 wherein the brightness control input comprises:
a user manipulated control member coupled to the display.

6. The apparatus of claim 4 wherein:
the brightness control input is an ambient light signal.

7. The apparatus of claim 5 further comprising:
the control member connecting a power source to the display for turning the display on and off.

8. The apparatus of claim 1 further comprising:
a power on and power off control member coupled to the display for controlling the application of electric power to the display.

9. The apparatus of claim 1 wherein:
a width of each longitudinally extending element of each LED character in the composite image is greater than a width of each laterally extending LED element of each LED character.

10. A viewed image of a heads up display comprising:
a first image of at least one LED heads up display character formed of a plurality of LED elements reflected off an inner surface of a vehicle windshield toward a viewer;
a second image of the at least one LED element at least refracted from the vehicle windshield toward a viewer; and
the first and second images disposed in an overlapping composite image to the viewer.

11. The viewed image of claim 10 wherein the first and second images are partially overlapped.

12. The viewed image of claim 10 wherein the composite image comprises:
LED elements of each LED character extending vertically and horizontally as viewed by the viewer;
the vertically extending elements of the first and second images being disposed in overlapping arrangement in the composite image; and
the horizontally extending elements of the first and second images are juxtaposed in the composite images.

13. The viewed image of claim 12 wherein:
the horizontally extending first and second image elements are juxtaposed to each other to each form a single enlarged combined width horizontally extending composite viewed image.

14. The viewed image of claim 12 wherein:
the vertically extending first and second elements overlap to form a single, brighter, vertically extending element in the composite viewed image.

15. The viewed image of claim 10 wherein:
a width of each longitudinally extending element of each LED character in the composite image is greater than a width of each laterally extending LED element of each LED character in the composite image.

16. A method of forming an LED display having at least one LED character output formed of horizontally and vertically extending reflected and refracted elements comprising the steps of:
determining a width of each vertically extending LED element and the width of each horizontally extending LED element of a reflected image and a refracted image of each LED character to define a single composite, at least partially overlapped image to the viewer taking into consideration the inclination angle of a vehicle windshield, with respect to the orientation of the LED display, the thickness of the vehicle windshield, and the refraction index of the material forming the vehicle windshield.

17. The method of claim 16 further comprising the steps of:
mounting an LED display in a vehicle; and
reflecting an image of at least one LED character forming the LED display from the windshield toward a viewer.

18. The method of claim 17 further comprising:
coupling a vehicle operating parameter input to the LED display.

19. The method of claim 18 comprising the step of:
selecting the vehicle operating input to be at least one of the vehicle speed, the vehicle engine rpm, the vehicle fuel quantity, the vehicle turn signal condition, and
the vehicle headlight condition.

20. The method of claim 17 further comprising the step of:
coupling a brightness control input to the LED display for controlling the brightness of the LED display character output.

21. The method of claim 17 comprising the step of:
forming the composite image of the first and second images to include LED elements for each LED character extending vertically and horizontally as viewed by the viewer;
disposing the vertically extending elements of the first and second images in overlapping arrangement; and
disposing the horizontally extending elements of the composite image in a juxtaposed arrangement.

22. The method of claim 21 comprising the step of:
juxtaposing each horizontally extending first and second image element to each other to each form a single enlarged combined width composite image element.

23. The method of claim 21 comprising the step of:
overlapping each vertically extending first and second element to form a single brighter element in the composite image viewed by the viewer.

24. The method of claim 21 comprising the step of:
forming a width of each longitudinally extending element of each LED character in the composite image greater than a width of each laterally extending LED element of each LED character.
